(19) United States
(12) Patent Application Publication
(10) Pub. No.: US 2022/0390748 A1
(43) Pub. Date: Dec. 8, 2022

(54) Optical Systems including Light-Guide Optical Elements with Two-Dimensional Expansion

(71) Applicant: LUMUS LTD., Ness Ziona (IL)

(72) Inventors: Yochay DANZIGER, Kfar Vradim (IL); Elad SHARLIN, Mishmar David (IL)

(21) Appl. No.: 17/796,656

(22) PCT Filed: Apr. 5, 2021
(86) PCT No.: PCT/IL2021/050382

§ 371 Date: Jul. 31, 2022

Related U.S. Application Data
(60) Provisional application No. 63/005,369, filed on Apr. 5, 2020.

(51) Int. Cl. G02B 27/01; F21V 8/00

(52) U.S. Cl. CPC G02B 27/0172; G02B 6/0035; G02B 2027/0123

(57) ABSTRACT

An optical system includes an image redirecting arrangement with at least two reflectors to direct a collimated image from an image projector so as to propagate within a light-guide optical element (LOE) in first and second directions, to be subsequently reflected by corresponding first and second sets of partially-reflecting internal surfaces towards a coupling-out optical arrangement. A part of a field of view (FOV) adjacent to the right side of the collimated image propagating in the first direction crosses a plane of one of the sets of partially-reflecting internal surfaces or a plane parallel to the major external surfaces, thereby forming self-overlap of a part of the collimated image in a region of the field of view which does not reach the eye of a user.

### FIELD AND BACKGROUND OF THE INVENTION

The present invention relates to optical systems and, in particular, it concerns an optical system including a light-guide optical element (LOE) for achieving optical aperture expansion.

Many near-eye display systems include a transparent light-guide optical element (LOE) or “waveguide” placed before the eye of the user, which conveys an image within the LOE by internal reflection and then couples out the image by a suitable output coupling mechanism towards the eye of the user. The output coupling mechanism may be based on embedded partial reflectors or “facets”, or may employ a diffractive element. The description below will refer primarily to a facet-based coupling-out arrangement.

Various LOE configurations for achieving two-dimensional expansion of an optical aperture of an image projector are disclosed in U.S. Pat. No. 10,551,544 and PCT Patent Application Publication No. WO 2020/049542 A1, which are both co-assigned with the present application. In these examples, a first set of partially-reflecting facets progressively reflect an image injected into the LOE so as to redirect it from a first direction to a second direction while achieving a first dimension of aperture expansion, and a second set of partially-reflecting facets progressively couple-out the redirected image while achieving a second dimension of aperture expansion.

When implementing such configurations with a large field of view, the range of angles which can be used is limited at one extremity by the requirement that all rays of the image propagating within the LOE must impinge on the major surfaces of the LOE at an angle of incidence greater than the critical angle. At the other extremity, if the angular field of the image within the LOE crosses the center plane of the LOE, certain rays of the image will overlap (i.e., be in the same direction) as rays of the conjugate image, leading to corruption of that part of the image. Additional limitations are imposed by the planes of partially-reflecting surfaces (“facets”) within the LOE, since any part of the image field which crosses the plane of the facets is corrupted by reflection onto the adjacent region of the image. These considerations complicate design of an LOE for two-dimensional aperture expansion and impose limits on the angular field of images which can be displayed.

### SUMMARY OF THE INVENTION

The present invention is an optical system for directing image illumination to an eye-motion box for viewing by an eye of a user.

According to the teachings of an embodiment of the present invention there is provided, an optical system for directing an image to an eye-motion box for viewing by an eye of a user, the optical system comprising: (a) an image projector projecting illumination corresponding to a collimated image having an angular field of view from a left side to a right side and from a top to a bottom, and a chief ray central to the field of view denoting a direction of propagation; (b) a light-guide optical element (LOE) formed from transparent material and having first and second mutually-parallel major external surfaces; (c) an image redirecting arrangement comprising at least a first reflector deployed to redirect part of the illumination in a first direction within the LOE so that the collimated image propagates by internal reflection within the LOE in the first direction and at least a second reflector deployed to redirect part of the illumination in a second direction within the LOE so that the collimated image propagates by internal reflection within the LOE in the second direction; (d) a coupling-out optical arrangement associated with the LOE and configured for deflecting illumination propagating within the LOE outwards towards the eye-motion box; and (e) a plurality of sets of partially-reflecting internal surfaces within the LOE, the plurality of sets including a first set of mutually-parallel partially-reflecting internal surfaces deployed for redirecting the illumination propagating in the first direction towards the coupling-out optical arrangement, and a second set of mutually-parallel partially-reflecting internal surfaces deployed non-parallel to the first set of partially-reflecting internal surfaces for redirecting the illumination propagating in the second direction towards the coupling-out optical arrangement, wherein the part of the illumination redirected in the first direction and redirected by the first set of partially-reflecting internal surfaces provides at least a left side of the field of view to the eye-motion box, and wherein a part of the field of view adjacent to the right side of the collimated image propagating in the first direction crosses a plane of one of the sets of partially-reflecting internal surfaces or a plane parallel to the major external surfaces, thereby forming self-overlap of a part of the collimated image in a region of the field of view which does not reach the eye-motion box.

According to a further feature of an embodiment of the present invention, the part of the illumination redirected in the second direction and redirected by the second set of partially-reflecting internal surfaces provides at least a right side of the field of view to the eye-motion box, and wherein a part of the field of view adjacent to the left side of the collimated image propagating in the second direction crosses a plane of one of the sets of partially-reflecting internal surfaces or a plane parallel to the major external surfaces, thereby forming self-overlap of a part of the collimated image in a region of the field of view which does not reach the eye-motion box.

According to a further feature of an embodiment of the present invention, the image redirecting arrangement comprises a reflective prism external to the LOE that provides the first reflector and the second reflector.

According to a further feature of an embodiment of the present invention, the first reflector is a reflective surface internal to the LOE and parallel to the first set of partially-reflecting internal surfaces and the second reflector is a reflective surface internal to the LOE and parallel to the second set of partially-reflecting internal surfaces.

According to a further feature of an embodiment of the present invention, the first set of partially-reflecting internal surfaces and the second set of partially-reflecting internal surfaces are in overlapping relation in at least one region of the LOE.

According to a further feature of an embodiment of the present invention, the first set of partially-reflecting internal surfaces and the second set of partially-reflecting internal surfaces are each at an oblique angle to the major external surfaces of the LOE.

According to a further feature of an embodiment of the present invention, a part of the field of view adjacent to the right side of the collimated image propagating in the first direction crosses a plane of the second set of partially-reflecting internal surfaces.

According to a further feature of an embodiment of the present invention, a part of the field of view adjacent to the right side of the collimated image propagating in the first direction crosses the plane parallel to the major external surfaces.

According to a further feature of an embodiment of the present invention, the coupling-out optical arrangement comprises a third set of mutually-parallel partially-reflecting internal surfaces non-parallel to both the first set and the second set, the third set of mutually-parallel partially-reflecting internal surfaces being at an oblique angle to the major external surfaces of the LOE.

### BRIEF DESCRIPTION OF THE DRAWINGS

The invention is herein described, by way of example only, with reference to the accompanying drawings, wherein:

FIGS. 1A and 1B are schematic isometric views of an optical system implemented using a light-guide optical element (LOE), constructed and operative according to the teachings of a first aspect of the present invention, illustrating a top-down and a side-injection configuration, respectively;

FIG. 2A is a schematic isometric view illustrating a field of view (FOV) of an image as observed by an eye of the user;

FIG. 2B is a schematic top view illustrating the regions of an LOE from which the left and right extremities of the FOV are provided to an eye-motion box (EMB);

FIG. 2C is a view similar to FIG. 2B additionally illustrating extremities of the field of view projected from regions of the LOE which do not reach the EMB and which can therefore, according to an aspect of the present invention, be allowed to become corrupted;

FIG. 3A is a sequence of schematic representations of angular space illustrating a sequence of reflections for alternative optical paths providing the right side (top of figure) and left side (bottom of figure) of a field of view;

FIGS. 3B(1) and 3B(2) are schematic top views of a high-quality portion and a corrupted portion of a projected image from the right and left sides of the LOE, respectively, where only the high-quality portion of the projected image reaches the EMB;

FIGS. 3C and 3D are a series of schematic front views and a side view, respectively, illustrating the optical paths of FIG. 3A in physical space;

FIGS. 3E and 3F are three-dimensional angular representations of the sequence of reflections illustrated in FIG. 3A, where FIG. 3E includes arrows illustrating the sequence of reflections while FIG. 3F designates a region of each image which undergoes corruption;

FIGS. 4A and 4B are three-dimensional angular representations similar to FIGS. 3E and 3F for an alternative implementation of the present invention;

FIGS. 5A and 5B are three-dimensional angular representations similar to FIGS. 3E and 3F for a further alternative implementation of the present invention;

FIGS. 6-8 are schematic representations of respective components and the overall assembled structure for three alternative implementations of an LOE according to the teachings of embodiments of the present invention;

FIG. 9 is a graph illustrating angular dependence of reflectivity for a partially-reflecting internal surface (facet) for an implementation of the present invention, illustrating also the angular extent of various images propagating within the LOE;

FIG. 10 is a schematic front view of an implementation of the LOE of FIGS. 1A-8 illustrating central downwards injection of a coupled-in image;

FIG. 11A is a view similar to FIG. 10 illustrating an implementation with perpendicular injection of a coupled-in image;

FIGS. 11B and 11C are schematic cross-sectional views taken along a line XI-XI of FIG. 11A, showing first and second implementations of an image redirection arrangement for coupling-in a projected image in two directions;

FIG. 12A is a view similar to FIG. 10 illustrating an implementation with upwards injection of a coupled-in image;

FIGS. 12B and 12C are schematic cross-sectional views taken along a line XII-XII of FIG. 12A, showing first and second implementations for coupling-in of a projected image in an upward direction;

FIG. 13A is a schematic angular representation of a further implementation of the present invention employing a first and second set of partially-reflecting internal surfaces that are perpendicular to the major external surfaces of the LOE; and

FIG. 13B is a schematic front view of an LOE corresponding to the embodiment of FIG. 13A.

### DESCRIPTION OF THE PREFERRED EMBODIMENTS

The present invention is an optical system for directing image illumination to an eye-motion box for viewing by an eye of a user.

The principles and operation of optical systems according to the present invention may be better understood with reference to the drawings and the accompanying description.

By way of introduction, certain aspects of the present invention relate to an optical system for directing image illumination via a light-guide optical element (LOE) to an eye-motion box (EMB) for viewing by an eye of a user. The optical system provides optical aperture expansion for the purpose of a head-up display, and most preferably a near-eye display, which may be a virtual reality display, or more preferably an augmented reality display. The optical system preferably provides two-stage expansion of an input optical aperture, and where the first expansion is achieved using two distinct sets of mutually-parallel partially-reflecting surfaces (“facets”), each set handing a different part (non-identical but preferably overlapping) of an overall field-of-view (FOV) presented to the eye.

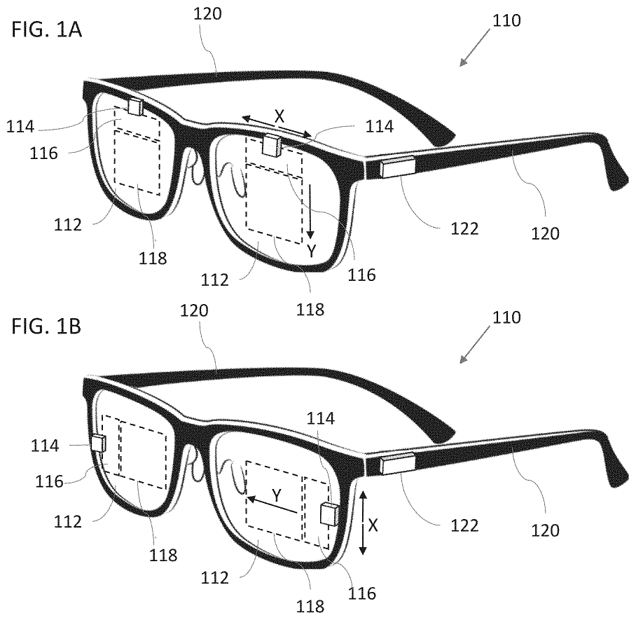

In typical but non-limiting embodiments (FIGS. 1A and 1B), the optical system employs a single image projector (“POD”) providing image illumination to two sets of facets that are integrated into the LOE. In generic terms, FIGS. 1A and 1B show an optical system for directing image illumination injected into at least one coupling-in region to an eye-motion box for viewing by an eye of a user. The optical system includes a light-guide optical element (LOE) 112 formed from transparent material, and including a first region 116 containing a first set of planar, mutually-parallel, partially-reflecting surfaces (“facets”) having a first orientation and a second set of planar, mutually-parallel, partially-reflecting surfaces (“facets”) having a second orientation non-parallel to the first orientation. (The facets are not visible in FIGS. 1A and 1B, but will be illustrated schematically in drawings below.) The LOE also includes a second region 118 containing a third set of planar, mutually-parallel, partially-reflecting surfaces (or “facets,” also referred to as “out-coupling surfaces”), having a third orientation non-parallel to each of the first orientation and the second orientation. The LOE is bounded by a set of mutually-parallel major external surfaces extending across the first and second regions such that the first, second and third sets of partially-reflecting surfaces are all located between the major external surfaces.

The third set of partially-reflecting surfaces are at an oblique angle to the major external surfaces so that a part of the image illumination propagating within the LOE by internal reflection at the major external surfaces from the first region into the second region is coupled out of the LOE towards the eye-motion box for viewing by the eye of the eye of the user. Alternatively, instead of the third set of facets, a diffractive optical element may be used in second region 118 for progressively coupling-out the image illumination towards the eye motion box. Similarly, a diffractive optical element may be used for coupling the image illumination from projector 114 into the LOE so as to propagate within first region 116 by internal reflection.

Each of the first and second sets of partially-reflecting surfaces is oriented so that a part of the image illumination propagating within the LOE by internal reflection at the major external surfaces from the at least one coupling-in region is deflected towards the second region.

Most preferably, each of the first and second sets of facets account for aperture expansion for a distinct part of the overall field of view. Specifically, the first set of partially-reflecting surfaces preferably deflects a first part of a field of view of the image towards the second region and the second set of partially-reflecting surfaces deflects a second part of the field of view of the image towards the second region, the first and second parts of the field of view combining to provide a continuous combined field of view larger than each of the first and second parts of the FOV. The two parts of the FOV preferably correspond roughly to two sides (left-right or top-bottom, but arbitrarily referred to hereinbelow as “left” and “right”) of the total FOV, but with sufficient overlap of the central region to ensure full and continuous coverage of the center field across the eye-motion box, corresponding to the acceptable range of positions of the pupil of the observer for which the display is designed.

Exemplary implementations of the invention assume the form of a near-eye display, generally designated 110, employing LOE 112. The compact image projector (or “POD”) 114 is optically coupled so as to inject an image into the LOE 112 (interchangeably referred to as a “waveguide,” a “substrate” or a “slab”), within which the image light is trapped in one dimension by internal reflection at the planar major external surfaces. The light impinges on the first and second sets of partially-reflecting surfaces (interchangeably referred to as “facets”), where each set of facets is inclined obliquely to the direction of propagation of the image light, with each successive facet deflecting a proportion of the image light into a deflected direction, also trapped/guided by internal reflection within the substrate. These first and second sets of facets are not illustrated individually in FIGS. 1A and 1B, but are located in a first region of the LOE designated 116. This partial reflection at successive facets achieves a first dimension of optical aperture expansion.

The first and second sets of partially-reflecting surfaces, located in region 116, deflect the image illumination from a first direction of propagation trapped by total internal reflection (TIR) within the substrate to a second direction of propagation, also trapped by TIR within the substrate. This partial reflection at successive facets achieves a first dimension of optical aperture expansion.

The deflected image illumination then passes into second substrate region 118, which may be implemented as an adjacent distinct substrate or as a continuation of a single substrate, in which a coupling-out optical arrangement (either a further set of partially reflective facets or a diffractive optical element) progressively couples out a proportion of the image illumination towards the eye of an observer located within a region defined as the eye-motion box (EMB), thereby achieving a second dimension of optical aperture expansion. The overall device may be implemented separately for each eye, and is preferably supported relative to the head of a user with the each LOE 112 facing a corresponding eye of the user. In one particularly preferred option as illustrated here, a support arrangement is implemented as an eye glasses frame with sides 120 for supporting the device relative to ears of the user. Other forms of support arrangement may also be used, including but not limited to, head bands, visors or devices suspended from helmets.

Reference is made herein in the drawings and claims to an X axis which extends horizontally (FIG. 1A) or vertically (FIG. 1B), in the general extensional direction of the first region of the LOE, and a Y axis which extends perpendicular thereto, i.e., vertically in FIG. 1A and horizontally in FIG. 1B.

In very approximate terms, first region 116 of LOE 112, may be considered to achieve aperture expansion in the X direction while the second LOE, or second region 118 of LOE 112, achieves aperture expansion in the Y direction. The details of the spread of angular directions in which different parts of the field of view propagate will be addressed more precisely below. It should be noted that the orientation as illustrated in FIG. 1A may be regarded as a “top-down” implementation, where the image illumination entering the main (second region) of the LOE enters from the top edge, whereas the orientation illustrated in FIG. 1B may be regarded as a “side-injection” implementation, where the axis referred to here as the Y axis is deployed horizontally. In the remaining drawings, the various features of certain embodiments of the present invention will be illustrated in the context of a “top-down” orientation, similar to FIG. 1A. However, it should be appreciated that all of those features are equally applicable to side-injection implementations, which also fall within the scope of the invention. In certain cases, other intermediate orientations are also applicable, and are included within the scope of the present invention except where explicitly excluded. For conciseness and clarity of presentation, the two sides of the displayed image provided by the distinct first and second sets of facets are referred to below as “left” and “right” corresponding to the extremities in the X direction, although, as mentioned, the “left” and “right” do not necessarily correspond to horizontal separation in the final deployment orientation of the device.

In a first set of preferred but non-limiting examples of the present invention, the aforementioned first and second sets of facets are orthogonal to the major external surfaces of the substrate. In this case, both the injected image and its conjugate undergoing internal reflection as it propagates within region 116 are deflected and become conjugate images propagating in a deflected direction. In an alternative set of preferred but non-limiting examples, the first and second sets of partially-reflecting surfaces are obliquely angled relative to the major external surfaces of the LOE. In the latter case, either the injected image or its conjugate forms the desired deflected image propagating within the LOE, while the other reflection may be minimized, for example, by employing angularly-selective coatings on the facets which render them relatively transparent to the range of incident angles presented by the image whose reflection is not needed.

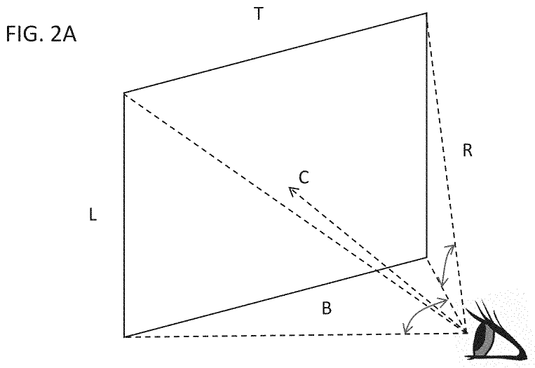

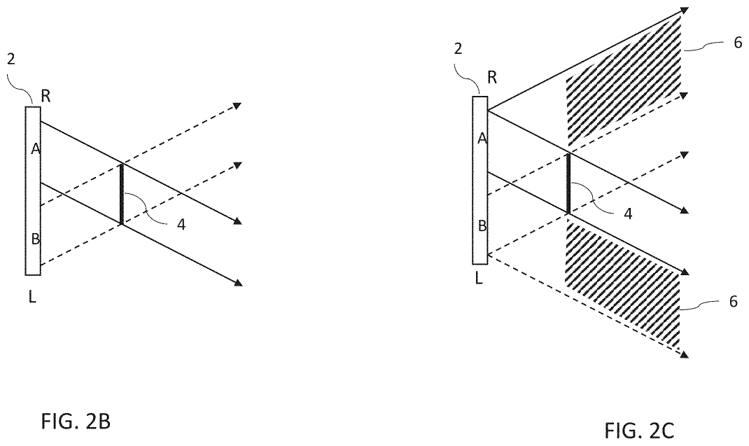

The POD employed with the devices of the present invention is preferably configured to generate a collimated image, i.e., in which the light of each image pixel is a parallel beam, collimated to infinity, with an angular direction corresponding to the pixel position. The image illumination thus spans a range of angles corresponding to an angular field of view in two dimensions. This angular field is represented schematically in FIG. 2A, where the user's eye observes a field of view, in this case rectangular, extending from a left side “L” to a right side “R”, and from a top edge “T” to a bottom edge “B”. A representative direction of propagation is taken to be a central direction corresponding to a chief ray “C”.

Image projector 114 includes at least one light source, typically deployed to illuminate a spatial light modulator, such as an LCOS chip. The spatial light modulator modulates the projected intensity of each pixel of the image, thereby generating an image. Alternatively, the image projector may include a scanning arrangement, typically implemented using one or more fast-scanning mirror, which scans illumination from a laser light source across an image plane of the projector while the intensity of the beam is varied synchronously with the motion on a pixel-by-pixel basis, thereby projecting a desired intensity for each pixel. In both cases, collimating optics are provided to generate an output projected image which is collimated to infinity. Some or all of the above components are typically arranged on surfaces of one or more polarizing beam-splitter (PBS) cube or other prism arrangement, as is well known in the art.

Optical coupling of image projector 114 to LOE 112 may be achieved by any suitable optical coupling, such as for example via a coupling prism with an obliquely angled input surface, or via a reflective coupling arrangement, via a side edge and/or one of the major external surfaces of the LOE. Alternatively, a diffractive optical element (DOE) may be used for coupling the image into the substrate. Details of the coupling-in configuration are typically not critical to the invention, other than as specified in certain examples below, and are otherwise shown here only schematically.

It will be appreciated that the near-eye display 110 includes various additional components, typically including a controller 122 for actuating the image projector 114, typically employing electrical power from a small onboard battery (not shown) or some other suitable power source. It will be appreciated that controller 122 includes all necessary electronic components such as at least one processor or processing circuitry to drive the image projector, all as is known in the art.

Referring now to the top view of FIG. 2B, it is noted that the right extremity of the projected image arriving at an EMB 4 originates from the region of the LOE 2 denoted “A”, whereas the left extremity of the projected image arriving at EMB 4 originates from region “B” of the LOE. The EMB designates the range of eye positions for which the optical system is required to provide a full FOV of the image. An aspect of the present invention utilizes this observation to allow partial corruption of the projected image in regions such as those labeled 6 in FIG. 2C, which do not reach the EMB 4 and therefore do not impact the quality of the image observed by the user.

Thus, according to one aspect of the present invention, there is particular significance to the manner in which the image from projector 114 is redirected towards the first and/or second sets of partially-reflecting surfaces. Specifically, according to this aspect of the present invention, the optical system further comprises an image redirecting arrangement including at least a first reflector deployed to redirect part of the image illumination in a first direction within LOE so that the collimated image propagates by internal reflection within the LOE in the first direction towards the first set of partially-reflecting internal surfaces and at least a second reflector deployed to redirect part of the illumination in a second direction within the LOE so that the collimated image propagates by internal reflection within the LOE in the second direction towards the second set of partially-reflecting internal surfaces. A part of the field of view adjacent to the right side of the collimated image propagating in the first direction crosses a plane of one of the sets of partially-reflecting internal surfaces or a plane parallel to the major external surfaces, thereby forming self-overlap of a part of the collimated image. Since, however, the first set of partially-reflecting surfaces provides the left side of the image to the eye-motion box, this self-overlap corrupts the image in a region of the field of view which does not reach the eye-motion box.

Preferably, an opposite arrangement is used for the right side of the field of view. Specifically, a part of the field of view adjacent to the left side of the collimated image propagating in the second direction preferably crosses a plane of one of the sets of partially-reflecting internal surfaces or a plane parallel to the major external surfaces, thereby forming self-overlap of a part of the collimated image. Since, however, the second set of partially-reflecting surfaces provides the right side of the image to the eye-motion box, this self-overlap corrupts the image in a region of the field of view which does not reach the eye-motion box. Specific examples of the redirecting arrangement, and the corresponding impact on certain regions of the image which do not reach the eye-motion box, will be presented below.

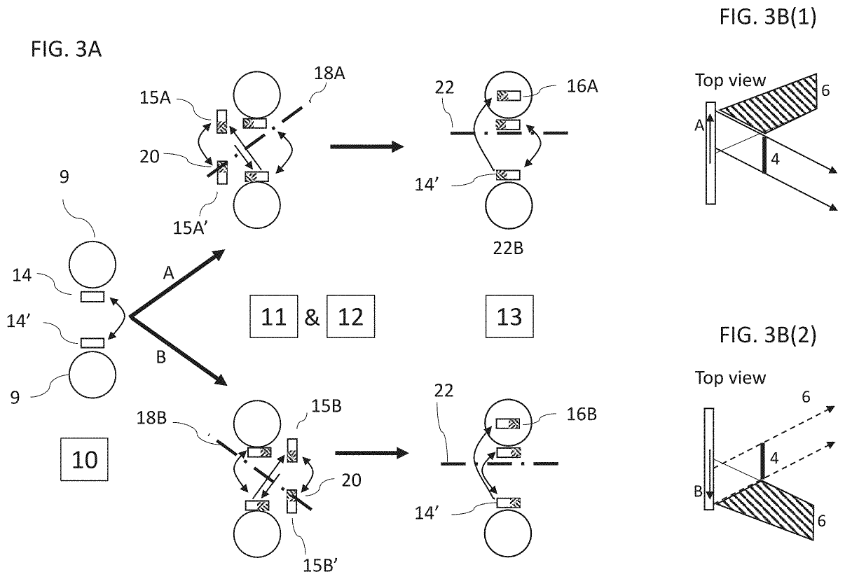

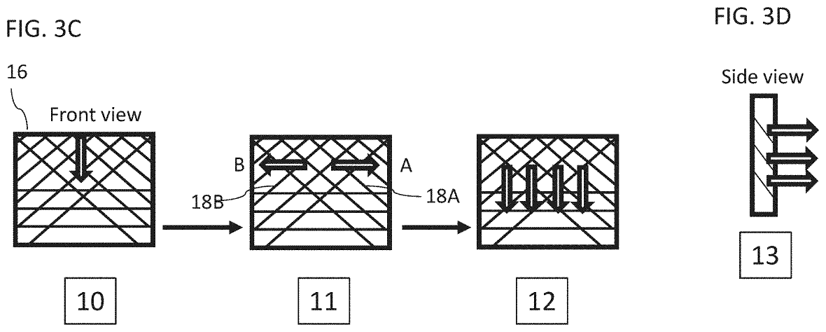

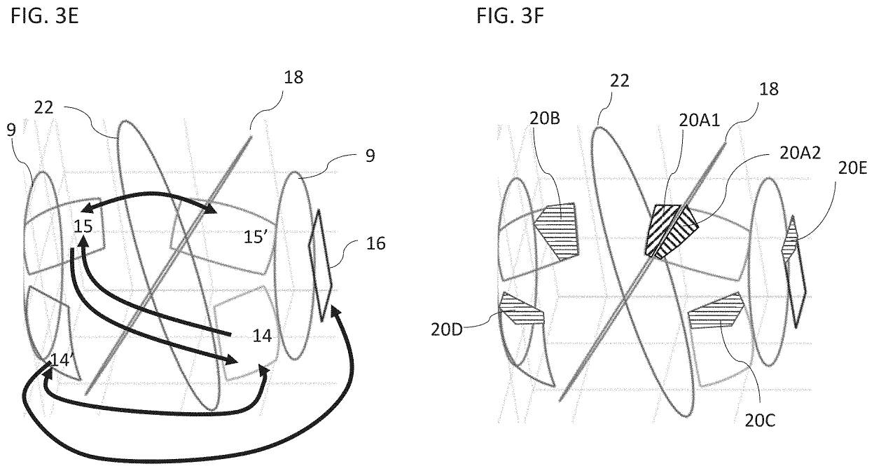

Turning now to FIGS. 3A-3D, these show schematically the two-dimensional aperture expansion of a large FOV according to a non-limiting example of the present invention. FIG. 3A illustrates the process in angular space while FIGS. 3B(1)-3D illustrate the equivalent process in real space.

The representation of FIG. 3A is based on a two-dimensional rectilinear representation of angular space in which spherical coordinates are portrayed in Cartesian coordinates. This representation introduces various distortions, and displacements along the different axes are non-commutative (as is the nature of rotations about different axes). Nevertheless, this form of diagram has been found to simplify the description and provide a useful tool for system design. The circles represent the critical angle (boundary of Total Internal Reflection—TIR) of the major external faces of the waveguides. Thus, a point outside a circle represents an angular direction of a beam that will be reflected by TIR, while a point inside a circle represents a beam that will pass the face and transmit out of the waveguide. The circles 9 represent the critical angle of the front and back external faces of the waveguide. The “distance” between the centers of the circles is 180 degrees.

These drawings illustrate 4 successive stages of image illumination progressing through the optical system after successive reflections. An initial state, after injection of a rectangular image 14 into the waveguide, is shown at stage 10. Since image 14 lies outside circles 9, its rays are guided by TIR as it propagates along the waveguide by internal reflection at the major surfaces of the waveguide (therefore presented as two coupled rectangles 14 and 14′). This propagation of the image is presented as an arrow in the real space description of the waveguide 16 shown in FIG. 3C, stage 10. Throughout this document, the real-space direction of propagation is illustrated with reference to an in-plane component of the propagation direction parallel to the major surfaces of the substrate. It will be appreciated that the arrow represents propagation through internal reflection, reflecting from the front and rear surfaces of the waveguide, and generally designates the in-plane component of the chief ray of the image.

As the image propagates in the waveguide, it encounters first and second reflectors of the redirecting optical arrangement, described in angular space as dot-dashed lines 18A and 18B, respectively. These facets causing the image to change direction as represented by rectangles 15A and 15B in angular space, each of which generates its own conjugate image 15A′ and 15B′, respectively, by internal reflection at the major external surfaces of the LOE. In real space (FIG. 3C, stage 11), the redirected image propagation directions are represented as laterally propagating arrows “A” and “B”.

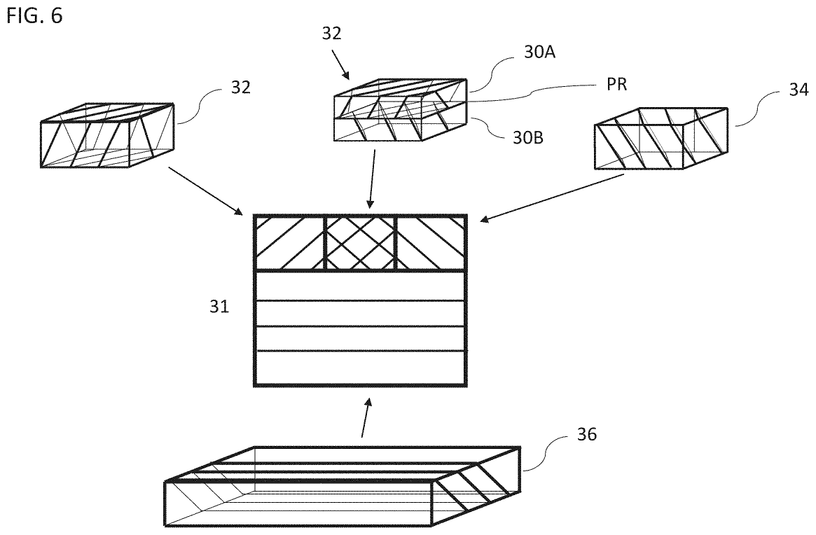

In this non-limiting example, the first reflector is a reflective surface internal to the LOE and parallel to the first set of partially-reflecting internal surfaces and the second reflector is a reflective surface internal to the LOE and parallel to the second set of partially-reflecting internal surfaces. Specific examples of how such a structure may be implemented will be described below with reference to FIGS. 6-8.

It is apparent that the facet plane 18A crosses one of the images 15A′ at a region 20. Consequently, this part of the image is reflected on itself causing this segment of the image to be unusable. This unusable segment is shaded within the rectangle image. A similar process occurs in the image redirected by facet 18B, with image 15B′ crossing the facet and resulting in a corrupted region 20. Although the multi-layer dielectric coatings employed to implement the partially-reflecting facets are in many cases designed to have low reflectivity at large angles of incidence, the reflectivity at grazing incidence is always high, so such coatings do not prevent corruption of an image which crosses the plane of the facet.

The deflected images are redirected by further reflection in the first and second sets of facets to images 14 and 14′. Because all of the guided images are coupled to each other, the unusable segment due to facet 18A is reproduced to all four images 14, 14′, 15A and 15A′, and likewise for the unusable segment generated by facet 18B. However, the image 15A propagating on one side of the LOE has an opposite unusable segment compared to the image 15B, as seen stage 12, which illustrates coupling out of image 14′ by coupling-out facet 22 to generate coupled-out images 16A and 16B. The top views (FIGS. 3B(1) and 3B(2)) show how each sub-image (A and B) illuminates eye-motion box 4 with the uncorrupted part of its respective image, while the unusable part of the image 6 is projected in a direction that lies outside the eye-motion box, and is therefore not seen by the user.

FIGS. 3E and 3F show in a three-dimensional angular representation the angular process described in FIG. 3A. Here, the planes of facets 18 and 22 are illustrated as circles. FIG. 3E shows the same images shown in FIG. 3A, while FIG. 3F shows the generation of the unusable section as folding 20A1 and 20A2 on each other around facet 18 and the combined unusable section propagates as 20B, 20C, 20D and couples out as 20E.

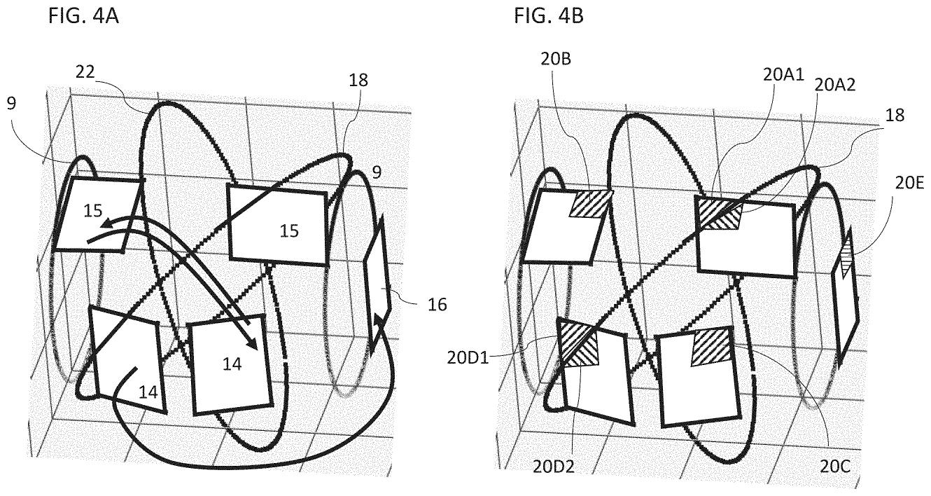

FIGS. 4A and 4B illustrate a different angular architecture (in a non-limiting example of an image with a form factor (ratio) of 4:3 and a diagonal of 70 degrees) according to an implementation of the present invention. Here however the facet angle crosses the image angular distribution twice at 20A and at 20D. Both unusable sections are overlapping, and therefore the end result is equivalent to that described above with reference to FIGS. 3A-3D.

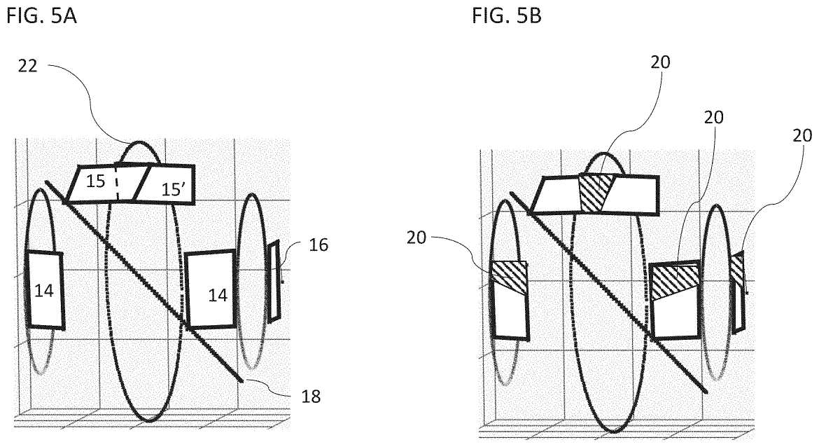

FIGS. 5A and 5B illustrate a situation where the images 15 and 15′ (the deflected image from facet 18 and its conjugate) are partly overlapping, thereby generating the unusable section 20. This corresponds to a case in which a part of the field of view adjacent to the right (or left) side of the collimated image propagating in the first (or second) direction crosses the plane parallel to the major external surfaces. This results in part of the image being folded on itself. As in previous examples, this unusable section illuminates only a region 6 outside the eye-motion box (FIG. 2B), while the eye-motion box 4 is illuminated from sections A and B with unperturbed regions of the image.

FIGS. 6, 7 and 8 describe various configurations and corresponding component parts of the waveguide. The dimensions are schematic for clarity of presentation. The actual size of every section is determined geometrically by the light path required to reach the eye-motion box.

In FIG. 6, the waveguide 31 is formed from four separate sections: the beam-splitting section 30 is made of two overlapping sections 30A and 30B having facets tilted at different orientations. The orientations of the facets do not have to be oppositely or symmetrically tilted, and correspondingly, the redirected image illumination from the first and second reflectors (18A and 18B) do not need to be in exactly opposite directions and other considerations can be taken into account, such as waveguide tilt relative to output image or different trimming of the two images.

For improved image uniformity a partial reflector (PR) can be introduced between the overlapping sections, parallel to the plane of the main external surfaces of the waveguide.

Here, the side section 32 preferably has facets parallel to 30A and section 34 has facets parallel to 30B in order to perform image reflection towards the second section 36 of the LOE. Section 36 is attached as continuation in order to couple light out towards the eye of the user, as shown in stage 13 of FIGS. 3A and 3B. In this example, all sections are attached side by side, with sections 30, 32 and 34 together making up the first waveguide section 116 of FIG. 1A or 1B, and section 36 corresponding to the second waveguide section 118.

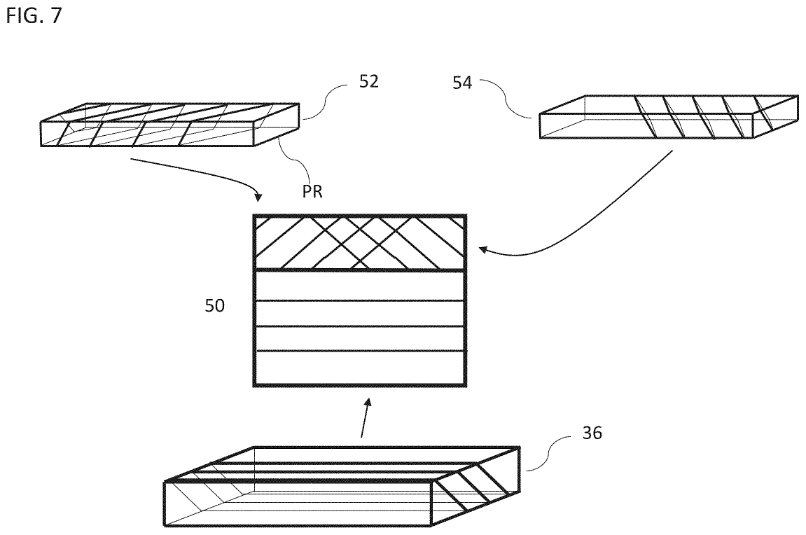

FIG. 7 shows a further optional implementation in which waveguide 50 is assembled from a section 52 overlayed above a section 54 to provide the first waveguide section 116 which achieves the beam splitting operations of the redirecting optical arrangement and the first and second sets of partially-reflecting surfaces. Section 36, corresponding to second waveguide section 118 of FIG. 1A or 1B, is placed as a continuation for coupling-out of the image. Here also, a partial reflector (PR) can be implemented as a coating between the overlapping sections (shown here below 52 that is to be attached in facing relation above 54). In both the cases of FIG. 6 and FIG. 7, the components may optionally be sandwiched between continuous cover sheets of glass, to facilitate achieving high quality planar external surfaces of the waveguide.

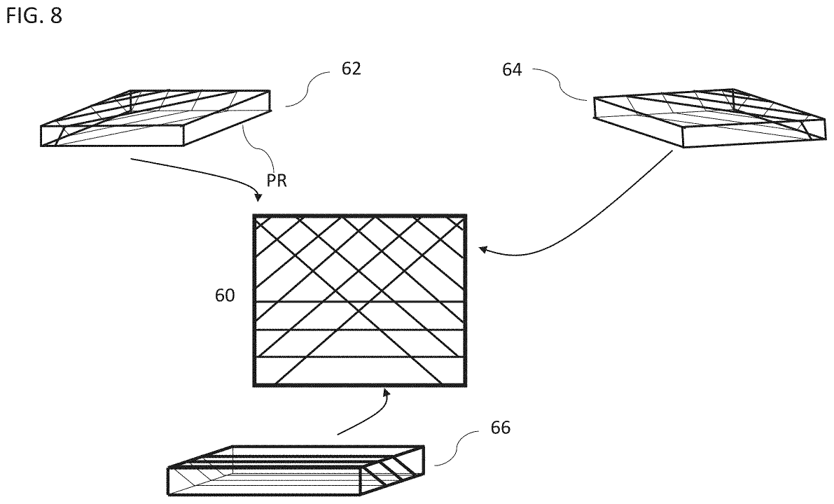

FIG. 8 illustrates a further option according to which all sections (62, 64 and 66) are placed one on top of the other to assemble the waveguide 60. Each section includes one set of facets, implemented at least in the relevant regions of the waveguide, and optionally extending across the entire dimensions of the waveguide, as shown. A partial reflector may be implemented at one or both of the interfaces in order to enhance image uniformity.

Implementing dielectric coatings to provide the required partially reflective properties for a large angular spectrum and for all colors can be challenging. In principle, standard software packages for designing multilayer dielectric coatings can be provided with the required reflectivity variation as a function of angle, and will generate a corresponding coating design. However, the more specific the requirements, the more complex and costly the coatings become, and/or the more compromises may have to be made regarding the desired performance. The present invention facilitates this aspect of the design, since angles corresponding to areas of the image which will anyway be corrupted, or will anyway not contribute to the image visible from the EMB, need not satisfy the reflectivity requirements required for the rest of the image.

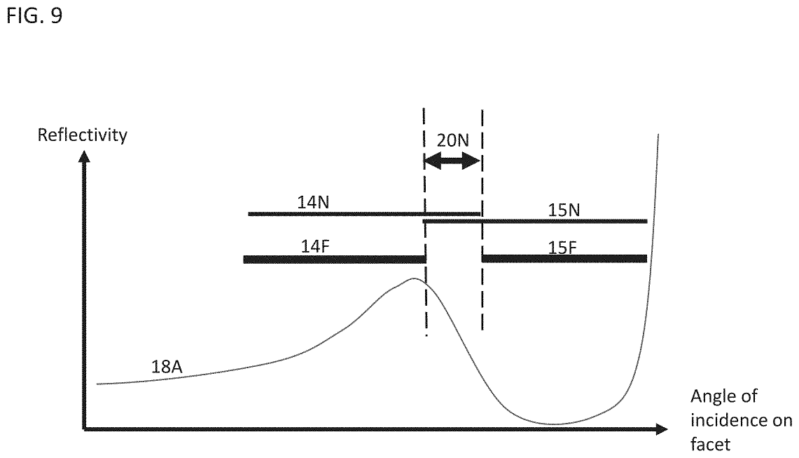

For example, FIG. 9 illustrates the angular reflectivity 18A of a typical implementation of a multi-layer dielectric coating of facet 18 for the implementation of FIG. 5. The angular spectrum of nominal image 14 is described here as line 14N and that of image 15 described here as 15N. The folding of image 15 on itself can be presented here as partial overlapping of 14N over 15N and the overlapping angular range is 20N (representing 20). Because range 20N does not include the high-quality image that will reach the eye-motion box, this region can be ignored (i.e., without imposed constraints) during the coating design. The actual range of reflectivity and transmittance required by the coating of facet 18A is thus effectively shorter, corresponding to lines 14F and 15F. This greatly facilitates design of suitable coatings.

This process of shortened dynamic spectrum is applicable to all other configurations shown thereby making the realization of facet coating for large FOV more practical.

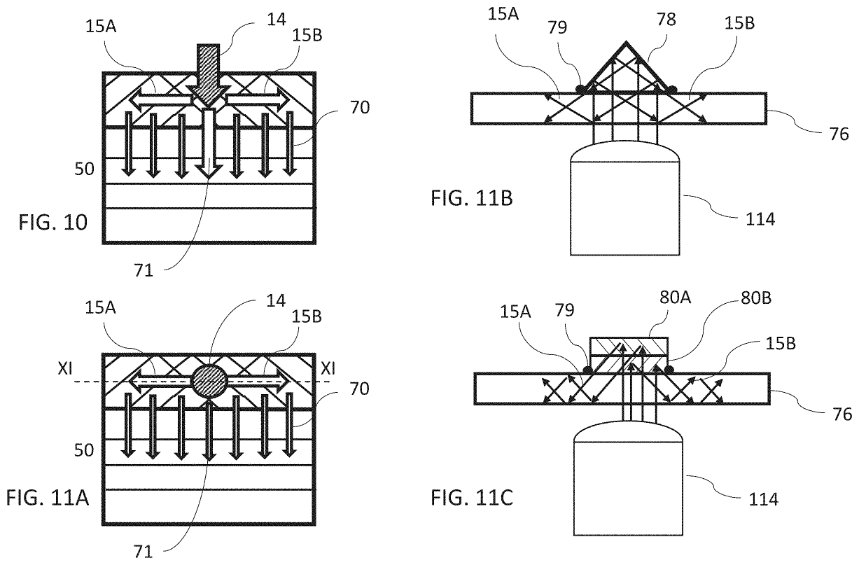

In the examples discussed thus far, the image illumination from image projector 114 is coupled into the first region 116 of the LOE prior to reaching the first and second reflectors of the image redirection arrangement, and those reflectors are integrated with the first and second sets of partially-reflecting internal surfaces. Coupling-in in this case can be achieved by any of the conventional arrangements known in the art, such as a coupling prism with an inclined surface, a coupling-in reflector, or a diffractive optical element. FIG. 10 shows schematically a power distribution along the waveguide for this family of solutions. The full input intensity of image illumination is injected as image 14 downward (in the arbitrary orientation illustrated) into the waveguide. Part of the light is coupled sideways 15A and 15B. This light is further coupled to the second waveguide section as light 70. Some of the injected light 14 continues without being reflected at the facets as light 71. This light typically has relatively high intensity and therefore will generate non uniformity of the projected image. This non-uniformity can be mitigated by implementing high reflectivity at some or all of the facets in segments 30, 52, 54, 62 and 64 (FIGS. 6-8).

FIG. 11A introduces an alternative optical architecture in which the first and second reflectors of the image redirection arrangement are part of a coupling-in arrangement for coupling light from the image projector (not shown) into the waveguide. In this case, the image 14 from the image projector is preferably injected perpendicular to the major surfaces of the LOE, as represented in FIG. 11A by circle 14. Two non-limiting examples of implementations of the image redirection arrangement are illustrated in FIGS. 11B and 11C.

In FIG. 11B the projector 114 has an exit pupil on a reflecting prism 78. The light from 114 is split by prism 78 to two beams: 15A coupled into one side of the waveguide and 15B coupled into the other side. In this configuration, there is no high intensity central beam like beam 71 of FIG. 10.

FIG. 11C illustrates an alternative implementation in which facet plates 80A and 80B, similar to 30A and 30B of FIG. 6, but attached outside the waveguide. The facets in these two sections deflect the light into sideways-propagating images 15A and 15B, as described above. Here too, no high intensity central beam is generated.

The two images 15A and 15B are injected into the waveguide after being reflected by the faces of prism 78 or the facets of plates 80A and 80B. During this injection, they are preferably also trimmed by edges 79 of the coupling-in arrangement. This trimming will be most significant for shallow beams. However, particularly for optical architectures of the type illustrated in FIGS. 5A and 5B, these most shallow beams typically correspond to the regions 20 which in any case do not contribute to the parts of the image that reach the EMB, so they can also be trimmed at the coupling-in stage without loss of performance. This allows the aperture of image projector 114 and the width of the reflectors 78 and 80 of the image redirection arrangement to be smaller than would theoretically be required to transmit all of the image field in two directions. This enables use of a smaller projector 114 and more concentrated energy.

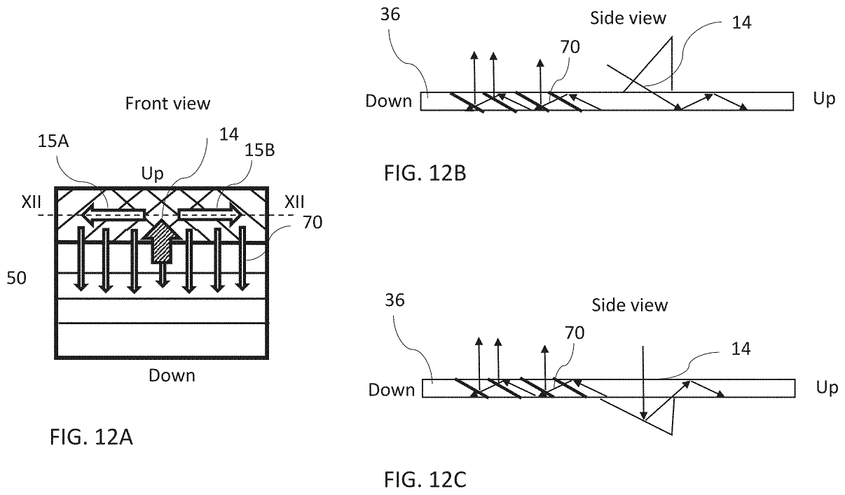

A further set of options is illustrated schematically in FIGS. 12A-12C. In this case, the high intensity input image beam 14 is deflected “upward”, i.e., away from the second region of the LOE where coupling-out occurs. This also avoids formation of a non-uniformity as discussed with reference to beam 71 of FIG. 10. The resultant geometry is shown schematically in FIG. 12A. Two specific non-limiting exemplary solutions for coupling the input image upwards are illustrated schematically in FIGS. 12B and 12C. In the case of FIG. 12B, a coupling-in prism provides a suitably oriented surface for coupling-in an upward-directed image while in FIG. 12C, a coupling-in prism provides a reflective surface for similar coupling-in of the image from the projector (not shown). In both cases, the first and second reflectors of the image redirection arrangement are here implemented as internal reflectors within the waveguide.

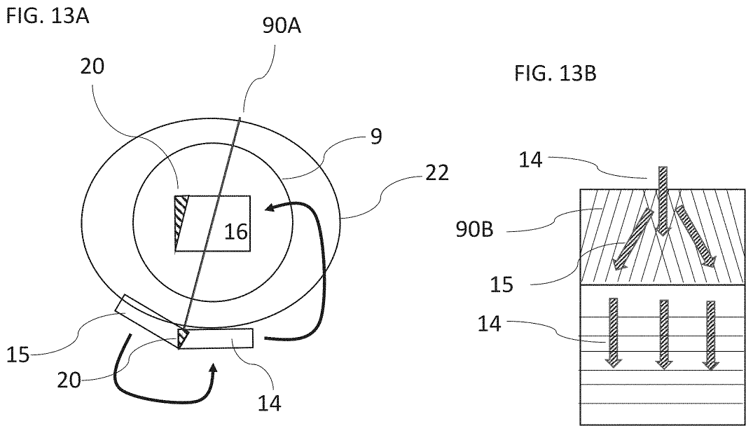

Finally, referring to FIGS. 13A and 13B, the principles of the present invention may also be applicable to cases of facets that are perpendicular to the major external surfaces of the substrate. FIG. 13A illustrates in angular space an example of perpendicular facets 90A (equivalent to tilted facets 18) where, for clarity, the projection is polar, looking along the output image 16 propagation direction. The injected image 15 is folded onto image 14 by perpendicular facet 90A. The overlap of 14 and 15 generates ghost image section 20. FIG. 13B illustrates the propagation of the same beams in real space. Here 90B are the perpendicular facets having equal but opposite inclination to facets 90A.

All of the above principles can also be applied to “sideway” configurations, where an image is injected from a POD located laterally outside the viewing area and is spread by a first set of facets vertically and then by a second set of facets horizontally for coupling into the eye of the user. All of the above-described configurations and variants should be understood to be applicable also in a side-injection configuration.

Throughout the above description, reference has been made to the X axis and the Y axis as shown, where the X axis is either horizontal or vertical, and corresponds to the first dimension of the optical aperture expansion, and the Y axis is the other major axis corresponding to the second dimension of expansion. In this context, X and Y can be defined relative to the orientation of the device when mounted on the head of a user, in an orientation which is typically defined by a support arrangement, such as the aforementioned glasses frame of FIGS. 1A and 1B. Other terms which typically coincide with that definition of the X axis include: (a) at least one straight line delimiting the eye-motion box, that can be used to define a direction parallel to the X axis; (b) the edges of a rectangular projected image are typically parallel to the X axis and the Y axis; and (c) a boundary between the first region 16 and the second region 18 typically extends parallel to the X axis.

It will be appreciated that the above descriptions are intended only to serve as examples, and that many other embodiments are possible within the scope of the present invention as defined in the appended claims.

What is claimed is:

1. An optical system for directing an image to an eye-motion box for viewing by an eye of a user, the optical system comprising:
(a) an image projector projecting illumination corresponding to a collimated image having an angular field of view from a left side to a right side and from a top to a bottom, and a chief ray central to said field of view denoting a direction of propagation;
(b) a light-guide optical element (LOE) formed from transparent material and having first and second mutually-parallel major external surfaces;
(c) an image redirecting arrangement comprising at least a first reflector deployed to redirect part of the illumination in a first direction within said LOE so that said collimated image propagates by internal reflection within said LOE in said first direction and at least a second reflector deployed to redirect part of the illumination in a second direction within said LOE so that said collimated image propagates by internal reflection within said LOE in said second direction;
(d) a coupling-out optical arrangement associated with said LOE and configured for deflecting illumination propagating within said LOE outwards towards the eye-motion box; and
(e) a plurality of sets of partially-reflecting internal surfaces within said LOE, said plurality of sets including a first set of mutually-parallel partially-reflecting internal surfaces deployed for redirecting the illumination propagating in said first direction towards said coupling-out optical arrangement, and a second set of mutually-parallel partially-reflecting internal surfaces deployed non-parallel to said first set of partially-reflecting internal surfaces for redirecting the illumination propagating in said second direction towards said coupling-out optical arrangement,
wherein said part of the illumination redirected in said first direction and redirected by said first set of partially-reflecting internal surfaces provides at least a left side of said field of view to the eye-motion box, and wherein a part of the field of view adjacent to the right side of the collimated image propagating in the first direction crosses a plane of one of said sets of partially-reflecting internal surfaces or a plane parallel to said major external surfaces, thereby forming self-overlap of a part of said collimated image in a region of the field of view which does not reach the eye-motion box.

2. The optical system of claim 1, wherein said part of the illumination redirected in said second direction and redirected by said second set of partially-reflecting internal surfaces provides at least a right side of said field of view to the eye-motion box, and wherein a part of the field of view adjacent to the left side of the collimated image propagating in the second direction crosses a plane of one of said sets of partially-reflecting internal surfaces or a plane parallel to said major external surfaces, thereby forming self-overlap of a part of said collimated image in a region of the field of view which does not reach the eye-motion box.

3. The optical system of claim 1, wherein said image redirecting arrangement comprises a reflective prism external to said LOE that provides said first reflector and said second reflector.

4. The optical system of claim 1, wherein said first reflector is a reflective surface internal to said LOE and parallel to said first set of partially-reflecting internal surfaces and said second reflector is a reflective surface internal to said LOE and parallel to said second set of partially-reflecting internal surfaces.

5. The optical system of claim 1, wherein said first set of partially-reflecting internal surfaces and said second set of partially-reflecting internal surfaces are in overlapping relation in at least one region of said LOE.

6. The optical system of claim 1, wherein said first set of partially-reflecting internal surfaces and said second set of partially-reflecting internal surfaces are each at an oblique angle to said major external surfaces of said LOE.

7. The optical system of claim 1, wherein a part of the field of view adjacent to the right side of the collimated image propagating in the first direction crosses a plane of said second set of partially-reflecting internal surfaces.

8. The optical system of claim 1, wherein a part of the field of view adjacent to the right side of the collimated image propagating in the first direction crosses said plane parallel to said major external surfaces.

9. The optical system of claim 1, wherein said coupling-out optical arrangement comprises a third set of mutually-parallel partially-reflecting internal surfaces non-parallel to both said first set and said second set, said third set of mutually-parallel partially-reflecting internal surfaces being at an oblique angle to said major external surfaces of said LOE.
